(19) United States
(12) Patent Application Publication
(10) Pub. No.: US 2013/0118414 A1
(43) Pub. Date: May 16, 2013

(54) ILLUMINATION DEVICE FOR USE IN AQUACULTURE AND AQUACULTURE DEVICE

(71) Applicants: Satoshi KOMADA, Osaka-shi (JP); Masaki TATSUMI, Osaka-shi (JP)

(72) Inventors: Satoshi KOMADA, Osaka-shi (JP); Masaki TATSUMI, Osaka-shi (JP)

(21) Appl. No.: 13/659,526

(22) Filed: Oct. 24, 2012

(30) Foreign Application Priority Data
Nov. 14, 2011 (JP) 2011-249127

(51) Int. Cl. A01K 63/06; H05B 33/02; H05B 37/02

(52) U.S. Cl. 119/215; 315/246; 313/503; 313/498

(57) ABSTRACT

A light emitting element for emitting at least two types of light having respective emission peak wavelengths which are different, by not less than 5 nm, from each other in the range of 400 nm to 570 nm, is provided in a fish preserve where fish is to be cultured.

This Nonprovisional application claims priority under 35 U.S.C. §119 on Patent Application No. 2011-249127 filed in Japan on Nov. 14, 2011, the entire contents of which are hereby incorporated by reference.

### TECHNICAL FIELD

The present invention relates to (i) an illumination device to be used for culturing fish and (ii) an aquaculture device.

### BACKGROUND ART

Conventionally, fish has been cultured so as to, for example, stably supply fish to consumers.

For example, tuna is cultured as follows: Approximately thirteen-week natural young tuna (having a body length of approximately 200 mm through 300 mm) caught in coastal waters is raised in a fish preserve provided in the sea to be large enough to be marketed. It is very important in tuna culture to stably feed tuna while preventing surprising action of the tuna in the fish preserve. What is meant by “surprising action” of tuna is a panic phenomenon in which tuna becomes excited by a rapid environmental change to swim madly. In a case where such a panic phenomenon occurs, plenty of tuna crash into walls of the fish preserve to death. Alternatively, tuna that took such surprising action tends to eat noting for several days after the surprising action. It becomes therefore difficult to manage a health condition of the tuna.

There is another problem that fish cultured in an aquaculture region such as a fish preserve dies out from a disease that spreads for a short period of time. Such a problem is caused by not only culturing fish in a closed region such as a fish preserve but also culturing the fish in the closed region far more densely than in the natural environment. At the present day, whether or not fish culture in a fish preserve is profitable depends on how much it is possible to prevent fish from dying in the fish preserve.

Patent Literature 1, which is an example of a technique regarding fish culture, discloses a method for preventing surprising action of tuna. Specifically, according to the method, the number of tuna which crashes into walls of a fish preserve to death at night is reduced, and a survival ratio of tuna is increased by irradiating, with light of not less than 101× (lux), a water surface under which immature tuna swims.

Patent Literature 2, which is another example of the technique regarding fish culture, discloses a fish culturing device. The fish culturing device irradiates fish with blue light from a blue light emitting diode so as to prevent a disease that is likely to spread in a situation where fish is cultured densely.

Thus, a light environment of growth environments under which, particularly, young fish that has just hatched grows is considered to greatly affect a survival ratio and growth of the young fish, though the ecology of young fish has been mostly still unclear.

### CITATION LIST

### Patent Literature

Patent Literature 1

Japanese Patent Application Publication, Tokukai No. 2011-19485 A (Publication Date: Feb. 3, 2011)

Patent Literature 2

Japanese Patent Application Publication, Tokukai No. 2004-159575 A (Publication Date: Jun. 10, 2004)

### SUMMARY OF INVENTION

### Technical Problem

It is necessary to consider visibility of fish in order to attain an effect on growth of the fish with a small amount of emission light. Generally, a half band width of a visibility curve is not less than 100 nm. This applies to fish.

Meanwhile, a half band width of an emission spectrum that depends on a wavelength of light emitted from a monochromatic LED (Light Emitting Diode) is in a range of 20 nm to 30 nm (the emission spectrum is hereinafter referred to simply as “emission spectrum”). Therefore, there is a problem that it is difficult to emit light in accordance with visibility of fish merely by use of the monochromatic LED.

However, Patent Literature 1 describes neither the problem nor a method for solving the problem, though discloses a method for preventing surprising action of tuna, in which method light of not less than 101× is emitted so as to reduce the number of tuna which crashes into walls of a fish preserve to death at night and increase a survival ratio of the tuna.

Further, it is apparent that a fish culturing device disclosed in Patent Literature 2 cannot solve the problem because it employs blue light merely from a monochromatic blue light emitting diode.

The present invention was made in view of the conventional problem, and an object of the present invention is to provide (i) an illumination device for use in aquaculture capable of emitting light in accordance with visibility of fish, and (ii) an aquaculture device.

### Solution to Problem

In order to solve the problem, an illumination device for use in aquaculture of the present invention is configured to be an illumination device for use in aquaculture, including at least one light emitting element for emitting at least two types of light having respective emission peak wavelengths which are different, by not less than 5 nm, from each other in a range of 400 nm to 570 nm.

As early described, generally, a half band width of a visibility curve is not less than 100 nm. This applies to fish, too. Meanwhile, for example, a half band width of an emission spectrum that depends on a wavelength of light emitted from a monochromatic LED is in a range of 20 nm to 30 nm. It is, however, preferable to use light having a broader half band width so as to improve visibility of fish. There is a problem that it is difficult to emit light in accordance with visibility of fish merely by use of the monochromatic LED.

In order to solve the problem, the illumination device for use in aquaculture of the present invention is configured to include at least one light emitting element for emitting at least two types of light having respective emission peak wavelengths which are different, by not less than 5 nm, from each other in a range of 400 nm to 570 nm (wavelength range).

Note here that the reason why “the respective emission peak wavelengths are different, by not less than 5 nm, from each other” is that, for example, a variation in LEDs themselves is considered (it is known that even identical LEDs have respective emission peak wavelengths whose variation falls within a range from approximately 2 nm to 3 nm). That is, the emission peak wavelengths are different from each other to such a degree that the variation in the emission peak wavelengths is greater than a variation in light emitting elements themselves.

The configuration makes it possible to further broaden an emission spectrum of whole light to be emitted. It is therefore possible to emit light in accordance with a visibility of fish.

Fish has a high visibility to light having the above wavelength range. Furthermore, it is necessary to select a wavelength of light that more efficiently passes through an aquaculture region (generally, water) where fish is cultured. This is because light is partially absorbed in the aquaculture region. The light having the above wavelength range has actually a higher transmittance in water than light having a wavelength outside the wavelength range.

According to the configuration of the present invention, it is possible to emit light in accordance with the visibility of fish. It is further possible to bring about a desired effect (secondary effect) with luminance lower than that of the light having the wavelength outside the wavelength range. This makes it possible to reduce (i) power consumption and (ii) cost incurred by employing artificial light in addition to natural light.

### Advantageous Effects of Invention

An illumination device for use in aquaculture of the present invention thus includes at least one light emitting element for emitting at least two types of light having respective emission peak wavelengths which are different, by not less than 5 nm, from each other in a range of 400 nm to 570 nm.

It is therefore possible to bring about an effect of emitting light in accordance with visibility of fish.

For a fuller understanding of the nature and advantages of the invention, reference should be made to the ensuing detailed description taken in conjunction with the accompanying drawings.

### BRIEF DESCRIPTION OF DRAWINGS

FIG. 1

FIG. 1 is a diagram illustrating an overall configuration of an aquaculture device in accordance with an embodiment of the present invention.

FIG. 2

FIG. 2 is a diagram illustrating an example configuration of a light emitting element of the aquaculture device.

FIG. 3

FIG. 3 is a diagram illustrating another example configuration of the light emitting element of the aquaculture device.

FIG. 4

FIG. 4 is a diagram illustrating yet another example configuration of the light emitting element of the aquaculture device.

FIG. 5

FIG. 5 is a diagram illustrating an overall configuration of an aquaculture device in accordance with another embodiment of the present invention.

FIG. 6

FIG. 6 is a graph showing an emission spectrum (that depends on a wavelength) obtained in Example of an illumination device for use in aquaculture, which device includes a blue LED and Lu₃Al₅O₁₂:Ce phosphors.

### DESCRIPTION OF EMBODIMENTS

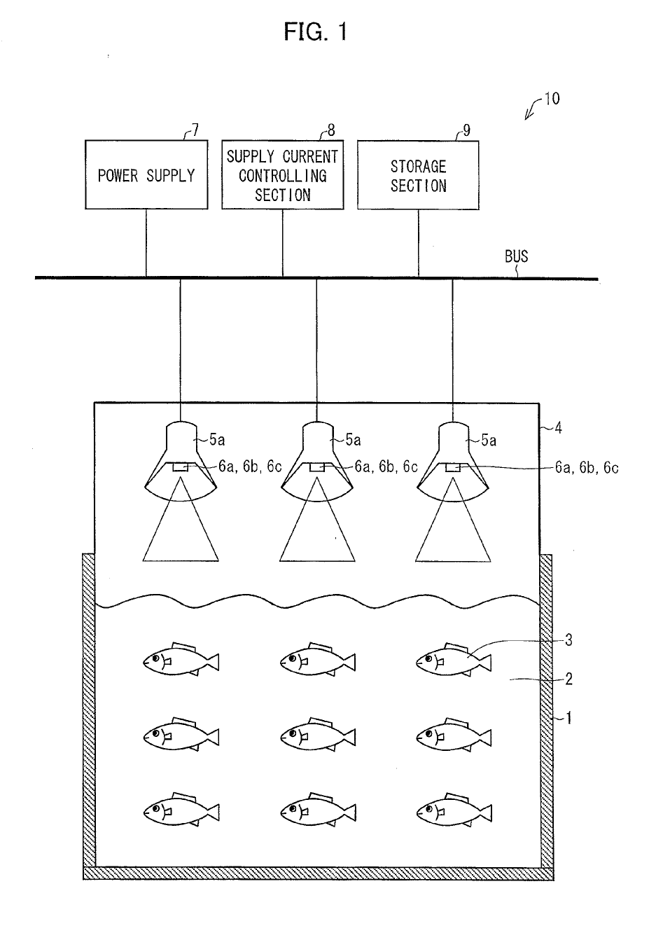

The following description will discuss an embodiment of the present invention with reference to FIGS. 1 through 6. Descriptions of some configurations other than configurations which are described in the following specific items will be omitted if necessary. In a case where such some configurations are described in other item(s), they have configurations identical to each other. Furthermore, for convenience of explanation, members having respective functions identical to those of members described in items are given respective identical reference numerals, and descriptions of those members are omitted as appropriate.

(1. Aquaculture Device 10)

Firstly, a configuration of an aquaculture device 10 that is an embodiment of an aquaculture device of the present invention will be described with reference to FIG. 1. FIG. 1 is a diagram illustrating an overall configuration of the aquaculture device 10.

The aquaculture device 10 includes a fish preserve (aquaculture region) 1, a support pillar 4, a housing 5a, a light emitting element (an illumination device for use in aquaculture) 6a, 6b, or 6c, a power supply (an illumination device for use in aquaculture) 7, a supply current controlling section (an illumination device for use in aquaculture) 8, and a storage section 9 (see FIG. 1).

Note that for simplicity, “a light emitting element 6a, a light emitting element 6b, or a light emitting element 6c” is hereinafter abbreviated to a “light emitting element 6a, 6b, 6c”. This applies to other members each having a plurality of reference numerals, too.

(Fish Preserve 1)

The fish preserve 1 is an example of an aquaculture region where fish 3 is cultured. Other examples of the aquaculture region encompass a tank and a culture pond. Specific examples of the aquaculture region encompass (i) a fish preserve or a tank made from a resin material or a glass material, (ii) a predetermined aquaculture region, in, for example, a sea, a river, or an artificial pond, which is surrounded with a sheet-like member, and (iii) an aquaculture region such as a fish preserve or a culture pond which is surrounded with, for example, concrete.

The fish preserve 1 stores water 2, and at least one fish 3 is released in the water 2. Examples of the water 2 encompass (i) sea water, (ii) water of, for example, a river, a lake or a pond, and (iii) specially prepared water for culturing fish. Note that it is preferable that the number of fish 3 be suitably determined by taking into consideration the volume of the fish preserve 1 so that density of the fish 3 does not become too dense in the fish preserve 1.

The fish preserve 1 of the present embodiment has a rectangular parallelepiped shape with an open upper end. The present embodiment is, however, not limited to this. The fish preserve 1 can have, for example, a cylindrical shape with an open upper end.

(Support Pillar 4)

The support pillar 4 of the present embodiment is made up of (i) two rod-like support members provided so as to be upright along respective side walls of the fish preserve 1 and (ii) a beam member that horizontally bridges between top edges of the respective two support members.

A plurality of light emitting elements 6a, 6b, 6c are connected to the beam member of the support pillar 4 via respective linear members such as threads, strings or wires so as to be aligned at appropriate intervals in a longitudinal direction of the beam member. That is, the support pillar 4 is a member for providing (fixing) the plurality of light emitting elements 6a, 6b, 6c so that the plurality of light emitting elements 6a, 6b, 6c can irradiate, from above, a water surface of the water 2 stored in the fish preserve 1 with light. Note that the plurality of light emitting elements 6a, 6b, 6c should be provided at appropriate intervals so that they can evenly irradiate with light the water surface of the water 2 stored in the fish preserve 1. This makes it possible to obtain a desired effect with less light. It is therefore possible to reduce (i) power consumption and (ii) cost incurred by employing artificial light in addition to natural light.

The plurality of light emitting elements 6a, 6b, 6c can be provided (fixed) by any methods, provided that they can irradiate, from above, the water surface of the water 2 stored in the fish preserve 1 with light. How to provide (fix) the plurality of light emitting elements 6a, 6b, 6c is not limited to the method described in the present embodiment.

(Housing 5a)

The housing 5a of the present embodiment includes a reflecting mirror having a substantially truncated cone shape with an open lower end. A light emitting element 6a, 6b, 6c is provided in the vicinity of a focal point of the reflecting mirror. The reflecting mirror reflects light emitted from the light emitting element 6a, 6b, 6c so that light beams that travel within a predetermined solid angle are formed. The reflecting mirror can be, for example, a member, having a curve shape (cup-like shape), which has (i) a surface coated with a metal thin film and (ii) an opening in a direction in which reflected light travels.

Such a reflecting mirror whose shape is appropriately designed can adjust the size of a spot of light so that the water surface of the water 2 stored in fish preserve 1 is evenly irradiated with the light. This makes it possible to obtain a desired effect with less light. It is therefore possible to reduce (i) power consumption and (ii) cost incurred by employing artificial light in addition to natural light.

(Light Emitting Element 6a, 6b, 6c)

The light emitting element 6a, 6b, 6c is an element for emitting, from above, at least two types of light to the water surface of the water 2 stored in the fish preserve 1 where the fish 3 is cultured. The at least two types of light have respective emission peak wavelengths which are different from each other by not less than 5 nm in a range of 400 nm to 570 nm. Note that a concrete example configuration of the light emitting element 6a, 6b, 6c will be described later.

Generally, a half band width of a visibility curve is not less than 100 nm. This applies to fish, too. Meanwhile, for example, a half band width of an emission spectrum that depends on a wavelength of light emitted from a monochromatic LED is in a range of 20 nm to 30 nm. It is, however, preferable to use light having a broader half band width so as to improve visibility of fish. There is a problem that it is difficult to emit light in accordance with visibility of fish merely by use of a monochromatic LED.

In order to address the problem, the light emitting element 6a, 6b, 6c is configured to emit, from above, the at least two types of light to an aquaculture region where fish is cultured (the water surface, of the water 2 stored in the fish preserve 1 where the fish 3 is cultured). The at least two types of light have the respective emission peak wavelengths which are different, by not less than 5 nm, from each other in the range of 400 nm to 570 nm (wavelength range).

Note here that the reason why “the respective emission peak wavelengths are different, by not less than 5 nm, from each other” is that, for example, a variation in LEDs themselves is considered (it is known that even identical LEDs have respective emission peak wavelengths whose variation falls within a range from approximately 2 nm to 3 nm). That is, the emission peak wavelengths are different from each other to such a degree that the variation in the emission peak wavelengths is greater than a variation in a plurality of LED chips themselves belonging to a first LED element group 11 (or a second LED element group 12) (later described) included in the light emitting element 6a, 6b, 6c.

The configuration makes it possible to further broaden an emission spectrum of whole light to be emitted to the water surface of the water 2 stored in the fish preserve 1. It is therefore possible to emit light in accordance with a visibility of the fish 3.

The fish 3 has a high visibility to light having the above wavelength range. Furthermore, it is necessary to select a wavelength of light that more efficiently passes through the water 2 stored in the fish preserve 1 because light is absorbed in the water 2. The light having the above wavelength range has a higher transmittance in the water 2 than light having a wavelength outside the above wavelength range. Furthermore, it is possible to improve a survival ratio and a growth rate of the fish 3 by irradiating the fish 3 with the light having a wavelength in the range of 400 nm to 570 nm.

Thus, the light emitting element 6a, 6b, 6c can bring about a desired effect, with luminance lower than that of the light having the wavelength outside the wavelength range. It is therefore possible to reduce (i) power consumption and (ii) cost incurred by employing artificial light in addition to natural light.

(Light Emitting Element 6a)

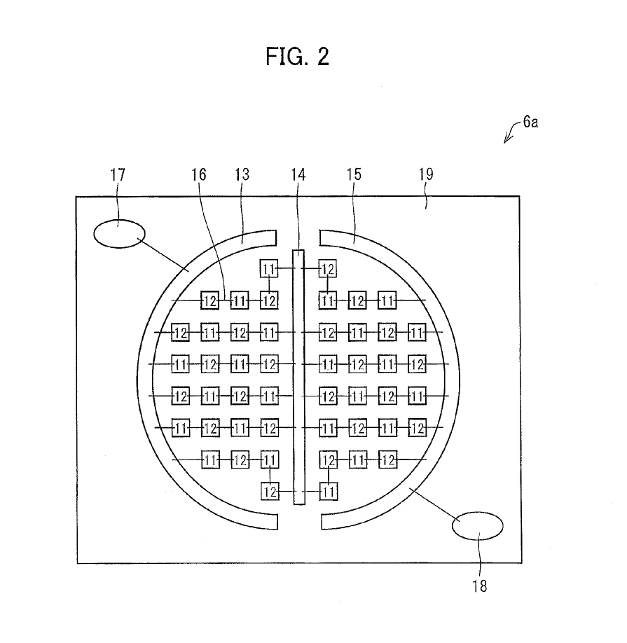

The following description will discuss a concrete example configuration of the light emitting element 6a with reference to FIG. 2. FIG. 2 is a diagram illustrating a configuration of the light emitting element 6a that is an example configuration of a light emitting element. The light emitting element 6a includes a first LED element group (first light emitting diode group) 11, a second LED element group (second light emitting diode group) 12, an anode electrode 13, gold 14, a cathode electrode 15, lines 16, a pad electrode (anode) 17, a pad electrode (cathode) 18, and a ceramic substrate 19 (see FIG. 2).

(First LED Element Group 11 and Second LED Element Group 12)

Each of the first LED element group 11 and the second LED element group 12 is made up of 24 LED chips (light emitting diodes) in total which have respective emission peak wavelengths which are different, by not less than 5 nm, from one another in a range of 480 nm to 520 nm.

The 24 LED chips, belonging to each of the first LED element group 11 and the second LED element group 12, each have an optical power of 0.1 W, an operating voltage of 3 V, and a driving current of 0.1 A. As such, the 24 LED chips have a total optical power of 2.4 W.

The fish 3 has a higher visibility to the light having an emission peak wavelength in the range of 480 nm to 520 nm. The light having such an emission peak wavelength range has a higher transmittance in the water 2 than the light having a wavelength outside the emission peak wavelength range.

This makes it possible to bring about a desired effect with luminance lower than that of the light having the wavelength outside the emission peak wavelength range. It is therefore possible to further reduce power consumption and the cost.

Each of the first LED element group 11 and the second LED element group 12 can be configured (i) so as to be made up of a plurality of LED chips each for emitting at least two types of light that have respective emission peak wavelengths which are different, by not less than 5 nm, from each other in a range of 430 nm to 550 nm and (ii) so that at least one of the plurality LED chips is an LED chip for emitting light having an emission peak wavelength in a range of 500 nm to 550 nm.

Transmittance of the water 2 tends to shift to a longer wavelength side in a coastal region or when a water quality of the water 2 is deteriorated. Therefore, a maximum transmittance varies in the range of 500 nm to 550 nm.

In terms of the visibility of the fish 3 and the transmittance of the water 2, it is thus preferable that an intensity of light to be emitted to the fish preserve 1 have a maximum emission spectrum in a blue-green region of 500 nm to 550 nm.

According to the configuration, each of the first LED element group 11 and the second LED element group 12 includes at least one LED chip for emitting light having the emission peak wavelength in the range of 500 nm to 550 nm. It is therefore possible to further increase the visibility of the fish 3 and the transmittance of the water 2.

The first LED element group 11 can be a group that includes at least one LED chip for emitting light having an emission peak wavelength in a range of 430 nm to 480 nm. The second LED element group 12 can be a group that includes at least one LED chip for emitting light having an emission peak wavelength in a range of 480 nm to 550 nm.

In this configuration, it is preferable that the second LED element group 12 further include at least one LED chip for emitting light having the emission peak wavelength in the range of 500 nm to 550 nm.

As early described, it is preferable that the intensity of the light to be emitted to the aquaculture region have the maximum emission spectrum in the blue-green region of 500 nm to 550 nm, in terms of visibility of fish and transmittance of water.

According to the configuration, the second LED element group 12 thus includes the at least one LED chip for emitting light having the emission peak wavelength in the range of 500 nm to 550 nm. It is therefore possible to further increase the visibility of the fish 3 and the transmittance of the water 2.

(Anode Electrode 13, Pad Electrode 17, Cathode Electrode 15, and Pad Electrode 18)

The anode electrode 13 is an electrode with which anodes of the first LED element group 11 and the second LED element group 12 are connected. The anode electrode 13 is electrically connected to the pad electrode 17.

The cathode electrode 15 is an electrode with which cathodes of the first LED element group 11 and the second LED element group 12 are connected. The cathode electrode 15 is electrically connected to the pad electrode 18.

The pad electrode (anode) 17 is electrically connected to an anode side of the power supply 7, and the pad electrode (cathode) 18 is electrically connected to a cathode side of the power supply 7.

(Gold 14 and Line 16)

Six lines of LED chips in total are electrically connected between the anode electrode 13 and the gold 14. In each of the six lines, two LED chips belonging to the first LED element group 11 and two LED chips belonging to the second LED element group 12 are connected in series with each other (see FIG. 2). This applies to six lines of LED chips electrically connected between the cathode electrode 15 and the gold 14 (see FIG. 2).

The gold 14 has a constant electric potential because it is provided between the anode electrode 13 and the cathode electrode 15. This causes a substantially uniform driving current to flow through each of the six lines of LD chips.

(Ceramic Substrate 19)

The ceramic substrate 19 is a base on which the first LED element group 11, the second LED element group 12, the anode electrode 13, the pad electrode 17, the cathode electrode 15, and the pad electrode 18 are fixed at respective appropriate locations.

In the present embodiment, a ceramic substrate is employed as the base. However, the base is not limited to the ceramic substrate. Alternatively, for example, a resin substrate or a glass substrate can be employed as the base.

The first LED element group 11 and the second LED element group 12 are mounted in a single package of the light emitting element 6a of the present embodiment. This makes it possible to evenly mix colors of light emitted from the respective LED chips. It is therefore more preferable to mount the first LED element group 11 and the second LED element group 12 in such a single package. Note that the plurality of LED chips belonging to the first LED element group 11 and the plurality of LED chips belonging to the second LED element group 12 can be individually mounted.

(Light Emitting Element 6b)

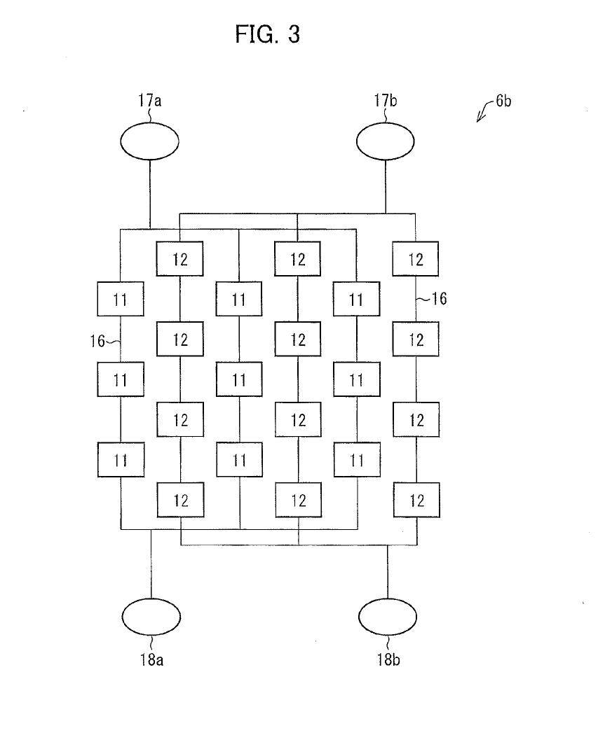

The following description will discuss a concrete example configuration of the light emitting element 6b with reference to FIG. 3. FIG. 3 is a diagram illustrating a configuration of the light emitting element 6b that is an example configuration of a light emitting element. Note that a first LED element group 11 and a second LED element group 12 of the light emitting element 6b can be mounted in a single package by use of a ceramic substrate 19, as with the light emitting element 6a. Note also that the following description will discuss, for simplicity, merely (i) how to connect LED chips belonging to the first LED element group 11 and (ii) how to connect LED chips belonging to the second LED element group 12, in the light emitting element 6b.

The light emitting element 6b includes the first LED element group (first light emitting diode group) 11, the second LED element group (second light emitting diode group) 12, lines 16, pad electrodes (anodes) 17a and 17b, and pad electrodes (cathodes) 18a and 18b (see FIG. 3).

(First LED Element Group 11 and Second LED Element Group 12)

The first LED element group 11 is made up of nine (9) LED chips (light emitting diodes) having respective emission peak wavelengths which are different, by not less than 5 nm, from one another in the range of 480 nm to 520 nm. The second LED element group 12 is made up of twelve (12) LED chips having respective emission peak wavelengths which are different, by not less than 5 nm, from one another in the range of 480 nm to 520 nm.

The LED chips, belonging to each of the first LED element group 11 and the second LED element group 12, each have an optical power of 0.1 W, an operating voltage of 3 V, and a driving current of 0.1 A. As such, the 21 LED chips have a total optical power of 2.1 W.

The fish 3 has a higher visibility to the light having an emission peak wavelength in the range of 480 nm to 520 nm. The light having such an emission peak wavelength range has a higher transmittance in the water 2 than the light having a wavelength outside the emission peak wavelength range.

This makes it possible to bring about a desired effect with luminance lower than that of the light having the wavelength outside the emission peak wavelength range. It is therefore possible to further reduce power consumption and the cost.

Each of the first LED element group 11 and the second LED element group 12 can be configured (i) so as to be made up of a plurality of LED chips each for emitting at least two types of light that have respective emission peak wavelengths which are different, by not less than 5 nm, from each other in a range of 430 nm to 550 nm and (ii) so that at least one of the plurality LED chips is an LED chip for emitting light having an emission peak wavelength in a range of 500 nm to 550 nm.

The transmittance of the water 2 tends to shift to a lower wavelength side in a coastal region or when water quality of the water 2 is deteriorated. Therefore, a maximum transmittance varies in the range of 500 nm to 550 nm.

In terms of the visibility of the fish 3 and the transmittance of the water 2, it is thus preferable that an intensity of light to be emitted to the fish preserve 1 have a maximum emission spectrum in the blue-green region of 500 nm to 550 nm.

According to the configuration, each of the first LED element group 11 and the second LED element group 12 includes at least an LED chip for emitting light having the emission peak wavelength in the range of 500 nm to 550 nm. It is therefore possible to further increase the visibility of the fish 3 and the transmittance of the water 2.

The first LED element group 11 can be a group that includes at least one LED chip for emitting light having an emission peak wavelength in the range of 430 nm to 480 nm. The second LED element group 12 can be a group that includes at least one LED chip for emitting light having an emission peak wavelength in the range of 480 nm to 550 nm.

In this configuration, it is preferable that the second LED element group 12 further include at least one LED chip for emitting light having the emission peak wavelength in the range of 500 nm to 550 nm.

As early described, it is preferable that the intensity of the light to be emitted to the aquaculture region have the maximum emission spectrum in the blue-green region of 500 nm to 550 nm, in terms of the visibility of fish and the transmittance of water.

According to the configuration, the second LED element group 12 thus includes the at least one LED chip for emitting light having the emission peak wavelength in the range of 500 nm to 550 nm. It is therefore possible to further increase the visibility of the fish 3 and the transmittance of the water 2.

According to the light emitting element 6b of the present embodiment, the number of the LED chips belonging to the second LED element group 12 is more than that of the LED chips belonging to the first LED element group 11.

This is because, in terms of the visibility of fish, it is preferable that the LED chips belonging to the second LED element group 12 emit brighter light than the LED chips belonging to the first LED element group 11.

It is further preferable that each of the LED chips belonging to the second LED element group 12 need a driving current greater than a driving current of each of the LED chips, belonging to the first LED element group 11, which emits light having an emission peak wavelength in a range of 430 nm to 470 nm. This is because, in terms of the visibility of fish, it is preferable that the LED chips belonging to the second LED element group 12 emit brighter light than the LED chips, belonging to the first LED element group 11, which emit light having the emission peak wavelength in the range of 430 nm to 470 nm.

Therefore, according to the light emitting element 6b illustrated in FIG. 3, the plurality of LED chips belonging to the first LED element group 11 are connected between the pad electrode 17a and the pad electrode 18a, whereas the plurality of LED chips belonging to the second LED element group 12 are connected between the pad electrode 17b and the pad electrode 18b. This allows a current driving to be individually carried out with respect to the first LED element group 11 and the second LED element group 12.

As described above, according to the light emitting element 6b, each of the LED chips belonging to the second LED element group 12 needs the driving current greater than that of each of the LED chips, belonging to the first LED element group 11, which emits light having the emission peak wavelength in the range of 430 nm to 470 nm.

(Light Emitting Element 6c)

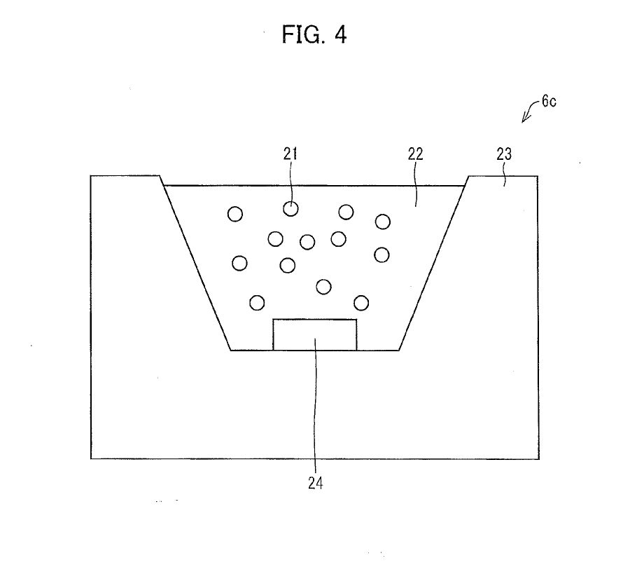

The following description will discuss a concrete example configuration of the light emitting element 6c with reference to FIG. 4. FIG. 4 is a diagram illustrating a configuration of the light emitting element 6c that is an example configuration of a light emitting element.

The light emitting element 6c includes a plurality of phosphors 21, a sealant resin 22, a package 23, and an LED chip (light emitting diode) 24 (see FIG. 4).

(Phosphor 21)

Phosphors 21 are each fluorescent material for emitting, in response to light emitted from the LED chip 24 (later described), fluorescence having an emission peak wavelength in a range of 480 nm to 570 nm.

It is preferable that the phosphor 21 be any one of BaSi₂O₂N₂:Eu, Lu₃Al₅O₁₂Ce, Y₃(Al,Ga)₅O₁₂:Ce, Y₃Al₅O₁₂:Ce, Sr₅F(PO₄)₃:Sb,Mn, Ca₃Sc₂Si₃O₁₂:Ce, and SrAl₂O₄:Eu²⁺,Dy³⁺.

It is preferable that the phosphor 21 be particularly any one of Lu₃Al₅O₁₂:Ce and Ca₃Sc₂Si₃O₁₂:Ce.

It is preferable that the phosphor 21 be SrAl₂O₄:Eu²⁺,Dy³⁺.

It is preferable that the phosphor 21 be BaSi₂O₂N₂:Eu, Lu₃Al₅O₁₂:Ce, or Y₂(Al,Ga)₅O₁₂:Ce. This is because BaSi₂O₂N₂:Eu, Lu₃Al₅O₁₂:Ce, and Y₃(Al,Ga)₅O₁₂:Ce each have a high excitation efficiency of blue light. It is preferable that the phosphor 21 be Sr₅F(PO₄)₃:Sb,Mn. This is because Sr₅F(PO₄)₃:Sb,Mn has an emission spectrum whose emission peak wavelength is in the vicinity of 500 nm. In especial, it is most preferable that the phosphors 21 be Lu₃Al₅O₁₂:Ce or Ca₃Sc₂Si₃O₁₂:Ce. This is because Lu₃Al₅O₁₂:Ce and Ca₃Sc₂Si₃O₁₂:Ce each have a high reliability and a broader emission spectrum. Consequently, the visibility of fish can be improved.

In a case where a light emitting diode is driven by a pulse current (later described), it is possible to employ a light storing green phosphor, such as SrAl₂O₄:Eu²⁺,Dy³⁺, which has a high weather resistance. The light storing green phosphor has an absorption spectrum (excitation spectrum) whose absorption peak wavelength is in an ultraviolet region. This causes a small reduction in excitation efficiency of the light storing green phosphor. However, since the light storing green phosphor has a long afterglow time, it is possible to reduce turn-on time of the LEDs (light period) to such an extent that fish can feel light (blue light) emitted from the light emitting diode. This allows a further reduction in power consumption. SrAl₂O₄:Eu²⁺,Dy³⁺ has an emission peak wavelength in a range of 530 nm to 540 nm.

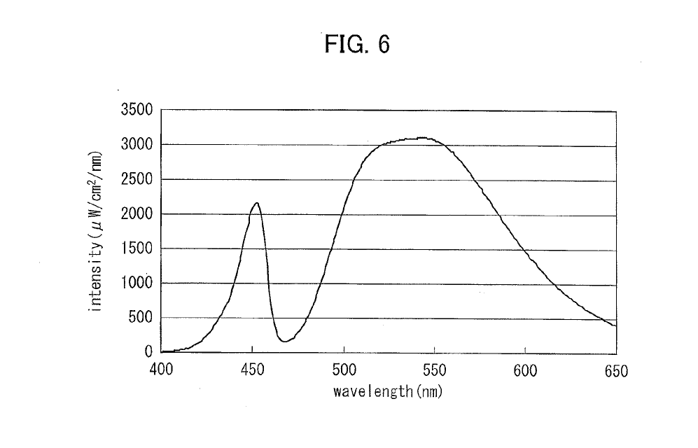

FIG. 6 shows an emission spectrum obtained in Example of an illumination device for use in aquaculture including the LED chip 24 (later described) and Lu₃Al₅O₁₂:Ce phosphors.

The phosphor 21 of the present embodiment has a particle diameter of approximately 10 μm. The present embodiment is not, however, limited to this. It is preferable that the particle diameter of the phosphor 21 be in a range of 5 μm to 20 μm.

(LED Chip 24)

The LED chip 24 is a light emitting diode for emitting light having an emission peak wavelength in a range of 400 nm to 460 nm.

The LED chip 24 has an optical power of 0.1 W, an operation voltage of 3 V, and a driving current of 0.1 A.

The light emitting element 6c of the present embodiment is configured to emit at least two types of light (i.e., light emitted from the LED chip 24 and fluorescence emitted from the plurality of phosphors 21) with which the water 2 stored in the fish preserve 1 is irradiated.

As early described, note that there is a problem that it is difficult to emit light in accordance with visibility of fish just by use of a monochromatic LED.

In order to address the problem, the light emitting element 6c is configured to include (i) the LED chip 24 for emitting light having the emission peak wavelength in the range of 400 nm to 460 nm and (ii) the plurality of phosphors 21 each for emitting, in response to the light emitted from the LED chip 24, fluorescence having the emission peak wavelength in the range of 480 nm to 570 nm (in a blue-green region).

Generally, an emission spectrum of fluorescence emitted from a phosphor is broader than that of light emitted from a monochromatic LED.

With the configuration, the water 2 stored in the fish preserve 1 is irradiated with (i) the light emitted from the LED chip 24 and (ii) the fluorescence emitted from the plurality of phosphors 21. It is therefore possible to improve color rendering properties of the light with which the water 2 stored in the fish preserve 1 is irradiated.

The configuration makes it possible to further broaden an emission spectrum of whole light with which the water 2 stored in the fish preserve 1 is to be irradiated. It is therefore possible for the water 2 to be irradiated with light in accordance with the visibility of the fish 3.

The fish 3 has a high visibility to light having the above wavelength range. It is further necessary to select a wavelength of light that more efficiently passes through the water 2 stored in the fish preserve 1. This is because light is partially absorbed in the water 2. The light having the above wavelength range has actually a higher transmittance in the water 2 than light having a wavelength outside the above wavelength range.

Thus, the light emitting element 6c can bring about a desired effect with luminance lower than that of the light having the wavelength outside the wavelength range. It is therefore possible to reduce (i) power consumption and (ii) cost incurred by employing artificial light in addition to natural light.

In addition, the LED chip 24, which emits light (blue light) having the emission peak wavelength in the range of 400 nm to 460 nm, is preferable in view of the fact that (i) the LED chip 24 has a high efficiency and (ii) the blue light improves a growth rate and a bait ingestion ratio of fish.

It is preferable that a ratio of (i) a photon flux density of fluorescence which is emitted from the plurality of phosphors 21 and with which the water 2 of the fish preserve 1 is irradiated to (ii) a light flux density of light which is emitted from the LED chip 24 and with which the water 2 of the fish preserve 1 is irradiated be not less than two.

The light, having the emission peak wavelength in the range of 500 nm to 550 nm, has a highest transmittance in the water 2, and the fish 3 has a high visibility to the light. It is believed that the fluorescent (blue-green region) having the emission peak wavelength in the range of 480 nm to 570 nm has a more effective wavelength. It is thus preferable that the ratio of (i) the photon flux density of the fluorescence which is emitted from the plurality of phosphors 21 and with which the water 2 of the fish preserve 1 is irradiated to (ii) a light flux density of the light which is emitted from the LED chip 24 and with which the water 2 of the fish preserve 1 is irradiated be not less than two.

Note that light emitted from the light emitting element 6c can contain red components. It is, however, preferable that the light emitting element 6c does not include red phosphors in terms of efficiency.

(Sealant Resin 22 and Package 23)

The package 23 is a housing where the LED chip 24 and the plurality of phosphors 21 are to be mounted in a single package. The plurality of phosphors 21 are placed in a concave part of the open upper end of the package 23, and are sealed with the sealant resin 22.

The sealant resin 22 is made from (i) a resin material such as a silicone resin or (ii) a glass material such as inorganic glass or organic hybrid glass.

According to the light emitting element 6c of the present embodiment, the LED chip 24 and the plurality of phosphors 21 are thus mounted in the single package. This makes it possible to evenly mix colors of light emitted from respective LED chips. It is therefore more preferable to mount the LED chip 24 and the plurality of phosphors 21 in the single package. Note that the light emitting element 6c can be configured such that (i) the LED chip 24 and the plurality of phosphors 21 are individually mounted and (ii) light from the LED chip 24 and fluorescent from the plurality of phosphors 21 are optically combined by use of an optical member such as a mirror.

(Power Supply 7, Supply Current Controlling Section 8,. and Storage Section 9)

The power supply 7 supplies driving current to the light emitting element 6a, 6b, 6c. The supply current controlling section 8 controls a driving current to be supplied to the light emitting element 6a, 6b, 6c.

The storage section 9 stores in advance, for example, (i) data (a driving current value of the light emitting element 6a, 6b, 6c, a frequency of a pulse current, and a turn-on time (described later)) necessary for controlling of a driving current by the supply current controlling section 8 and (ii) a control program.

It is preferable that the supply current controlling section 8 control a driving current, which is to be supplied to the light emitting element 6a, 6b, 6c, to be converted into a pulse current. Brightness obtained in a case where light blinks looks stronger than that obtained in a chase where continuous light is emitted at a duty ration. It is therefore preferable to employ the pulse current in terms of reduction in power consumption.

It is preferable that the pulse current has a frequency of not more than 10 Hz so that a light period is clearly separated from a dark period.

It is preferable that the supply current controlling section 8 control the light emitting element 6a, 6b, 6c to be turned on (i.e., control a driving current to be supplied to the light emitting element 6a, 6b, 6c) from evening to tomorrow morning.

Young fish generally prefers a long light period. It is therefore preferable that the light emitting element 6a, 6b, 6c emit artificial light from evening (sunset) to tomorrow morning.

It is preferable that the supply current controlling section 8 control a driving current to be supplied to the light emitting element 6a, 6b, 6c for not less than 12 hours a day.

It is preferable that the light emitting element 6a, 6b, 6c emit light such that a light period becomes not less than 12 hours, in a season, such as winter, when the light period becomes shorter. This allows an improvement in growth rate of young fish.

(2. Aquaculture Device 20)

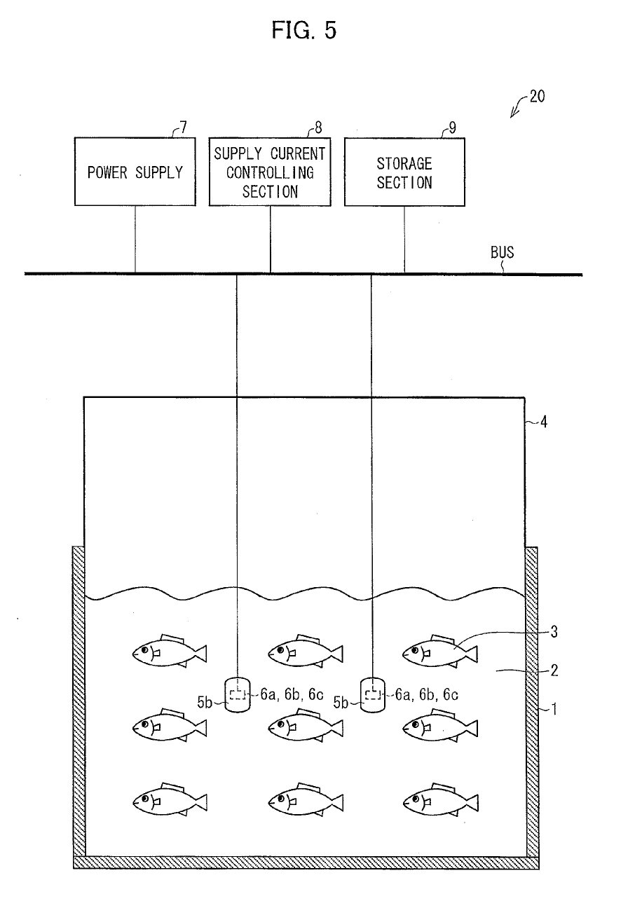

The following description will discuss a configuration of an aquaculture device 20 that is another embodiment of an aquaculture device of the present invention, with reference to FIG. 5. FIG. 5 is a diagram illustrating an overall configuration of the aquaculture device 20.

The aquaculture device 20 includes a fish preserve 1, a support pillar 4, a housing 5b, a light emitting element 6a, 6b, 6c, a power supply 7, a supply current controlling section 8, and a storage section 9 (see FIG. 5).

Note that the aquaculture device 20 of the present embodiment is different from the aquaculture device 10 just in the structure of the housing 5b and how to provide the light emitting element 6a, 6b, 6c. Therefore, description of the other configurations is omitted.

(Housing 5b and Light Emitting Element 6a, 6b, 6c)

The housing 5b of the present embodiment is a vessel made from a transparent resin material or a transparent member such as a glass material. A light emitting element 6a, 6b, 6c is provided in the housing 5b.

The light emitting element 6a, 6b. 6c provided in the housing 5b is put in water 2 stored in the fish preserve 1 (see FIG. 5).

The light emitting element 6a, 6b, 6c can be thus put in the water 2 stored in fish preserve 1 serving as an aquaculture region so as to emit light in the water 2. It is preferable to put the light emitting element 6a, 6b, 6c in the water 2 because it is possible to optimize a distribution of fish 3 by varying a depth at which the light emitting element 6a, 6b, 6c is put in the water 2.

(Relationship between Configurations of Aquaculture Device 10 or 20 and Light Emitting Element 6a, 6b, 6c)

The descriptions have discussed the aquaculture devices 10 and 20 in each of which each of the power supply 7, the supply current controlling section 8, and the storage section 9 is provided independently of the light emitting element 6a, 6b, 6c. The embodiments are, however, not limited to this. Alternatively, it is possible to configure an illumination device for use in aquaculture by integrating the power supply 7, the supply current controlling section 8 and/or the storage section 9 with the light emitting element 6a, 6b, 6c.

According to the configuration, it is possible to provide an aquaculture device capable of easily culturing the fish 3, by providing the illumination device for use in aquaculture such that the aquaculture region such as the fish preserve 1 is irradiated by the light emitting element 6a, 6b, 6c.

(3. Fish 3)

The following description will discuss the fish 3 to be cultured by the aquaculture device 10 or 20.

The fish 3 to be cultured by the aquaculture device 10 or 20 can be young fish.

It is possible to culture young fish while reducing (i) power consumption and (ii) cost incurred by employing artificial light in addition to natural light.

It is preferable that the young fish be 70 days old or younger.

Though depending on fish, young fish, which is 70 days old or younger, is sensitive to a light environment, prefers a bright environment, and tends to have an increased growth rate by being irradiated with light. Further, it is possible to prevent tuna from crashing to death by being irradiated with light.

The fish 3 to be cultured by the aquaculture device 10 or 20 can be thunnus.

Young fish of thunnus has a low optical sensitivity and a low time resolution by which a moving object is recognized. This causes a problem that many young fish crash into side walls of an aquaculture region such as the fish preserve 1, breaks their neck bone, and die. In contrast, the aquaculture device 10 or 20 thus includes the light emitting element 6a, 6b, 6c. It is therefore possible to prevent young tuna from crashing to death by irradiating the water 2 with light emitted from the light emitting element 6a, 6b, 6c. It is also possible to reduce (i) power consumption and (ii) cost incurred by employing artificial light in addition to natural light.

Examples of the fish 3 to be cultured by the aquaculture device 10 or 20 encompass carangidae, sparidae, gadinae, salmonidae, percichthyidae, latridae, and siganidae.

Young fish of carangidae, sparidae, gadinae, salmonidae, percichthyidae, latridae, and siganidae prefers a bright environment, and generally tends to have an increased growth rate by being irradiated with light emitted from the light emitting element 6a, 6b, 6c. It is also possible to reduce (i) power consumption and (ii) cost incurred by employing artificial light in addition to natural light. Note that the aquaculture devices 10 and 20 are effective in culturing particularly seriola (including young seriola quinqueradiata, seriola lalandi, seriora quinqueradiata, and seriola dumerili) of carangidae.

(Another Description of the Present Invention)

The present invention can also be described as below.

That is, an illumination device for use in aquaculture of the present invention can be configured to include a light emitting diode chip having a peak wavelength in a range of 480 nm to 520 nm.

The illumination device for use in aquaculture of the present invention can be further configured to include a plurality of light emitting diode chips having respective peak wavelengths which are different, by not less than 5 nm, from each other in a range of 430 nm to 550 nm.

The illumination device for use in aquaculture of the present invention can be further configured to include a plurality of light emitting diode chips, at least first one of which has a peak wavelength in a range of 430 nm to 480 nm, and at least second one of the other of which has a peak wavelength in a range of 480 nm to 550 nm.

The illumination device for use in aquaculture of the present invention can be further configured such that the plurality of light emitting diode chips are mounted in a single package.

The illumination device for use in aquaculture of the present invention can be further configured such that in the plurality of light emitting diode chips mounted in the single package, the number of light emitting diode chips having a peak wavelength in the range of 480 nm to 550 nm is greater than that of light emitting diode chips having a peak wavelength in the range of 430 nm to 480 nm.

The illumination device for use in aquaculture of the present invention can be further configured such that the at least second one of the plurality of light emitting diode chips needs a driving current greater than that of the at least first one of the plurality of light emitting diode chips.

The illumination device for use in aquaculture of the present invention can be further configured such that the plurality of light emitting diode chips are individually mounted, and the number of the at least second one of the plurality of light emitting diode chips is greater than that of the at least first one of the plurality of light emitting diode chips.

The illumination device for use in aquaculture of the present invention can be further configured to include (i) a light emitting diode chip having a peak wavelength in a range of 400 nm to 460 nm and (ii) a light emitting diode including a phosphor that has a peak wavelength in a range of 480 nm to 570 nm and that is excited by the light emitting diode chip.

The illumination device for use in aquaculture of the present invention can be further configured such that the phosphor is any one of BaSi₂O₂N₂:Eu, Lu₃Al₅O₁₂Ce, Y₃(Al,Ga)₅O₁₂:Ce, Y₃Al₅O₁₂:Ce, Sr₅F(PO₄)₃:Sb,Mn, and Ca₃Sc₂Si₃O₁₂:Ce.

The illumination device for use in aquaculture of the present invention can be further configured such that the phosphor is any one of Lu₃Al₅O₁₂:Ce and Ca₃Sc₂Si₃O₁₂:Ce.

The illumination device for use in aquaculture of the present invention can be further configured such that the phosphor is SrAl₂O₄:Eu²⁺,Dy³⁺.

The illumination device for use in aquaculture of the present invention can be further configured such that a ratio of (i) a photon flux density of light emitted from the phosphor to (ii) a light flux density of transmission light emitted from the light emitting diode chip, is not less than two.

The illumination device for use in aquaculture of the present invention can be further configured such that the light emitting diode chip is driven by a pulse current.

The illumination device for use in aquaculture of the present invention can be further configured such that the pulse has a frequency of not more than 10 Hz.

The illumination device for use in aquaculture of the present invention can be further configured such that the light emitting diode chip or the light emitting diode including the phosphor irradiates young fish with light.

The illumination device for use in aquaculture of the present invention can be further configured to irradiate with light the young fish that is 70 days old or younger.

The illumination device for use in aquaculture of the present invention can be further configured to irradiate with light the fish that is thunnus.

The illumination device for use in aquaculture of the present invention can be further configured to irradiate with light the fish that is any one of carangidae, sparidae, gadinae, salmonidae, percichthyidae, latridae, and siganidae.

The illumination device for use in aquaculture of the present invention can be further configured such that the light emitting diode chip or the light emitting diode including the phosphor is provided in water.

The illumination device for use in aquaculture of the present invention can be further configured such that the light emitting diode chip or the light emitting diode including the phosphor emits light from evening to tomorrow morning.

The illumination device for use in aquaculture of the present invention can be further configured such that the light emitting diode chip or the light emitting diode including the phosphor emits light from evening to tomorrow morning so that a light period becomes longer than a dark period.

The illumination device for use in aquaculture of the present invention can be further configured such that the at least one light emitting element includes a plurality of light emitting diodes having respective emission peak wavelengths which are different, by not less than 5 nm, from each other in a range of 480 nm to 520 nm.

Fish has a higher visibility to light having an emission peak wavelength in the range of 480 nm to 520 nm. Water transmits the light more efficiently than light having a wavelength other than the range of 480 nm to 520 nm.

This makes it possible to bring about a desired effect with luminance lower than that of the light having the wavelength other than the range of 480 nm to 520 nm. It is therefore possible to further reduce (i) power consumption and (ii) cost incurred by employing artificial light in addition to natural light.

The illumination device for use in aquaculture of the present invention can be further configured such that the at least one light emitting element includes a plurality of light emitting diodes having respective emission peak wavelengths which are different, by not less than 5 nm, from each other in a range of 430 nm to 550 nm, and at least one of the plurality of light emitting diodes emits light having an emission peak wavelength in a range of 500 nm to 550 nm.

Water transmittance tends to shift to a longer wavelength side in a coastal region or when a water quality is deteriorated. Therefore, a maximum transmittance varies in the range of 500 nm to 550 nm.

In terms of visibility of fish and the water transmittance, it is thus preferable that an intensity of light to be emitted to an aquaculture region have a maximum emission spectrum in a blue-green region of 500 nm to 550 nm.

According to the configuration, the illumination device for use in aquaculture of the present invention includes at least the light emitting diode for emitting the light having the emission peak wavelength in the range of 500 nm to 550 nm. It is therefore possible to further increase the visibility of the fish and the water transmittance.

The illumination device for use in aquaculture of the present invention can be further configured such that at least one of the plurality of light emitting diodes belongs to a first light emitting diode group for emitting light having an emission peak wavelength in a range of 430 nm to 480 nm, at least one of the other of the plurality of light emitting diodes belongs to a second light emitting diode group for emitting light having an emission peak wavelength in a range of 480 nm to 550 nm, and the second light emitting diode group includes at least one light emitting diode for emitting light having the emission peak wavelength in the range of 500 nm to 550 nm.

In terms of the visibility of fish and the water transmittance, it is thus preferable that the intensity of light to be emitted to the aquaculture region have the maximum emission spectrum in the blue-green region of 500 nm to 550 nm.

According to the configuration, the second light emitting diode group includes at least one light emitting diode for emitting the light having the emission peak wavelength in the range of 500 nm to 550 nm. It is therefore possible to further increase the visibility of fish and the water transmittance.

The illumination device for use in aquaculture of the present invention can be further configured such that the number of the at least one of the other of the plurality of light emitting diodes that belongs to the second light emitting diode group is greater than that of the at least one of the plurality of light emitting diodes that belongs to the first light emitting diode group.

In terms of the visibility of fish, it is preferable that the at least one of the other of the plurality of light emitting diodes that belongs to the second light emitting diode group emit brighter light than the at least one of the plurality of light emitting diodes that belongs to the first light emitting diode group.

Accordingly, the illumination device for use in aquaculture of the present invention is configured such that the number of the at least one of the other of the plurality of light emitting diodes that belongs to the second light emitting diode group is greater than that of the at least one of the plurality of light emitting diodes that belongs to the first light emitting diode group.

The illumination device for use in aquaculture of the present invention can be further configured such that the at least one of the other of the plurality of light emitting diodes that belongs to the second light emitting diode group needs a driving current greater than that of a light emitting diode, which belongs to the first light emitting diode group, for emitting light having an emission peak wavelength in a range of 430 nm to 470 nm.

In terms of the visibility of fish, it is preferable that the at least one of the other of the plurality of light emitting diodes that belongs to the second light emitting diode group emit brighter light than the light emitting diode, which belongs to the first light emitting diode group, for emitting the light having the emission peak wavelength in the range of 430 nm to 470 nm.

Accordingly, the illumination device for use in aquaculture of the present invention is configured such that the at least one of the other of the plurality of light emitting diodes that belongs to the second light emitting diode group needs a driving current greater than that of a light emitting diode, which belongs to the first light emitting diode group, for emitting light having an emission peak wavelength in a range of 430 nm to 470 nm.

The illumination device for use in aquaculture of the present invention can be configured such that the plurality of light emitting diodes are mounted individually or in a single package.

Note that it is more preferable that the plurality of light emitting diodes be mounted in the single package because it is possible to evenly mix colors of light (including fluorescence in a case where the fluorescence is emitted) emitted from the respective plurality of light emitting diodes.

The illumination device for use in aquaculture of the present invention can be further configured such that the at least one light emitting element includes: a light emitting diode for emitting light having an emission peak wavelength in a range of 400 nm to 460 nm; and a phosphor for emitting, in response to the light emitted from the light emitting diode, fluorescence having an emission peak wavelength in a range of 480 nm to 570 nm, and the light emitted from the light emitting diode, and the fluorescence emitted from the phosphor are the two types of light.

As early described, generally, a half band width of a visibility curve is not less than 100 nm. This applies to fish, too. Meanwhile, for example, a half band width of an emission spectrum of light emitted from a monochromatic LED is in the range of 20 nm to 30 nm. Therefore, there is a problem that it is difficult to emit light in accordance with visibility of fish merely by use of the monochromatic LED.

In order to solve the problem, the illumination device for use in aquaculture of the present invention is configured such that the at least one light emitting element includes: the light emitting diode for emitting the light having the emission peak wavelength in the range of 400 nm to 460 nm; and the phosphor for emitting, in response to the light emitted from the light emitting diode, the fluorescence having the emission peak wavelength in the range of 480 nm to 570 nm (in the blue-green region).

Generally, an emission spectrum of fluorescence emitted from a phosphor is broader than that of light emitted from a monochromatic LED.

With the configuration, the two types of light, which are the light emitted from the light emitting diode and the fluorescence emitted from the phosphor, are emitted. It is therefore possible to improve color rendering properties of emission light.

The configuration makes it possible to further broaden an emission spectrum of whole light with which an aquaculture region is to be irradiated. It is therefore possible for the aquaculture region to be irradiated with light in accordance with the visibility of fish.

Fish has a high visibility to light having the range of 400 nm to 570 nm. It is further necessary to select a wavelength of light that more efficiently passes through an aquaculture region (generally, water). This is because light is partially absorbed in the aquaculture region. The light having the range of 400 nm to 570 nm has actually a higher transmittance in water than light having a wavelength other than the range of 400 nm to 570 nm.

Thus, the configuration of the present invention makes it possible to bring about a desired effect with luminance lower than that of the light having the wavelength other than the range of 400 nm to 570 nm. It is therefore possible to reduce (i) power consumption and (ii) cost incurred by employing artificial light in addition to natural light.

In addition, the light emitting diode, which emits light (blue light) having the emission peak wavelength in the range of 400 nm to 460 nm, is preferable in terms of the fact that (i) the light emitting diode has a high efficiency and (ii) the blue light improves a growth rate and a bait ingestion ratio of fish.

The illumination device for use in aquaculture of the present invention can be further configured such that the phosphor is any one of (i) BaSi₂O₂N₂:Eu, (ii) Lu₃Al₅O₁₂:Ce, (iii) Y₃(Al,Ga)₅O₁₂:Ce, (iv) Y₃Al₅O₁₂:Ce, (v) Sr₅F(PO₄)₃:Sb,Mn, (vi) Ca₃Sc₂Si₃O₁₂:Ce, and (vii) SrAl₂O₄:Eu²⁺,Dy³⁺.

The illumination device for use in aquaculture of the present invention can be further configured such that the phosphor is one of Lu₃Al₅O₁₂:Ce and Ca₃Sc₂Si₃O₁₂:Ce.

The illumination device for use in aquaculture of the present invention can be further configured such that the phosphor is SrAl₂O₄:Eu²⁺,Dy³⁺.

It is preferable that the phosphor 21 be BaSi₂O₂N₂:Eu, Lu₃Al₅O₁₂:Ce, or Y₃(Al,Ga)₅O₁₂:Ce. This is because BaSi₂O₂N₂:Eu, Lu₃Al₅O₁₂:Ce, and Y₃(Al,Ga)₅O₁₂:Ce each have a high excitation efficiency of blue light. Further, it is preferable that the phosphor 21 be Sr₅F(PO₄)₃:Sb,Mn. This is because Sr₅F(PO₄)₃:Sb,Mn has an emission spectrum whose emission peak wavelength is in the vicinity of 500 nm. In especial, it is most preferable that the phosphor 21 be Lu₃Al₅O₁₂:Ce or Ca₃Sc₂Si₃O₁₂:Ce. This is because Lu₃Al₅O₁₂:Ce and Ca₃Sc₂Si₃O₁₂:Ce each have a high reliability and a broader emission spectrum.

In a case where a light emitting diode is driven by a pulse current, it is possible to employ a light storing green phosphor, such as SrAl₂O₄:Eu²⁺,Dy³⁺, which has a high weather resistance. The light storing green phosphor has an absorption spectrum (excitation spectrum) whose absorption peak wavelength is in an ultraviolet region. This causes a small reduction in excitation efficiency of the light storing green phosphor. However, since the light storing green phosphor has a long afterglow time, it is possible to reduce turn-on time (light period) of the light emitting diode to such an extent that fish can feel light (blue light) emitted from the light emitting diode. This allows further reduction in power consumption.

The illumination device for use in aquaculture of the present invention can be further configured such that a ratio of (i) a photon flux density of the fluorescence emitted from the phosphor to (ii) a light flux density of the light emitted from the light emitting diode, is not less than two.

The light, having the emission peak wavelength in the range of 500 nm to 550 nm, has a highest transmittance in water, and fish has a high visibility to the light. It is believed that the fluorescent (blue-green region) having the emission peak wavelength in the range of 480 nm to 570 nm has a more effective wavelength. It is thus preferable that the ratio of (i) the photon flux density of the fluorescence which is emitted from the phosphor to (ii) a light flux density of the light which is emitted from the light emitting diode be not less than two.

An illumination device for use in aquaculture of the present invention can be, configured to further include: a power supply for supplying a driving current to the at least one light emitting element; and a supply current controlling section for controlling the driving current to be supplied to the at least one light emitting element.

According to the configuration, it is possible to provide an aquaculture device capable of easily culturing fish by providing the illumination device for use in aquaculture of the present invention such that an aquaculture region such as a fish preserve is irradiated by the light emitting element.

An aquaculture device of the present invention can be configured to include: the illumination device for use in aquaculture; an aquaculture region where fish is to be cultured; a power supply for supplying a driving current to the at least one light emitting element; and a supply current controlling section for controlling the driving current to be supplied from the power source to the at least one light emitting element.

According to the configuration, it is possible to provide an aquaculture device including the illumination device for use in aquaculture of the present invention.

The illumination device for use in aquaculture of the present invention can be further configured such that the supply current controlling section controls the driving current, which is to be supplied to the at least one light emitting element, to be converted into a pulse current.

Brightness obtained in a case where light blinks looks stronger than that obtained in a case where continuous light is emitted at a duty ration. It is therefore preferable to employ the pulse current in terms of reduction in power consumption.

The illumination device for use in aquaculture of the present invention can be further configured such that the pulse current has a frequency of not more than 10 Hz.

According to the configuration, it is possible to clearly separate a light period from a dark period.

The aquaculture device of the present invention can be further configured to culture the fish that is young fish.

According to the configuration, it is possible to culture young fish while reducing (i) power consumption and (ii) cost incurred by employing artificial light in addition to natural light.

The aquaculture device of the present invention can be further configured to culture the young fish that is 70 days old or younger.

Though depending on fish, young fish, which is 70 days old or younger is sensitive to a light environment, prefers a bright environment, and tends to have an increased growth rate by being irradiated with light. Further, it is possible to prevent tuna from crashing to death by being irradiated with light.

The aquaculture device of the present invention can be further configured to culture the fish that is thunnus.

Young fish of thunnus has a low optical sensitivity and a low time resolution by which a moving object is recognized. This causes a problem that many young fish crash into side walls of an aquaculture region such as a fish preserve, breaks their neck bone, and die. In contrast, the aquaculture device of the present invention thus includes the illumination device for use in aquaculture. It is therefore possible to prevent young tuna from crashing to death by irradiating water with light emitted from the light emitting element. It is also possible to reduce (i) power consumption and (ii) cost incurred by employing artificial light in addition to natural light.

The aquaculture device of the present invention can be further configured to culture the fish that is any one of carangidae, sparidae, gadinae, salmonidae, percichthyidae, latridae, and siganidae.

Young fish of carangidae, sparidae, gadinae, salmonidae, percichthyidae, latridae, and siganidae prefers a bright environment, and generally tends to have an increased growth rate by being irradiated with light emitted from the light emitting element. It is also possible to reduce (i) power consumption and (ii) cost incurred by employing artificial light in addition to natural light. Note that the aquaculture device of the present invention is effective in culturing particularly seriola (including young seriola quinqueradiata, seriola lalandi, seriola quinqueradiata, and seriola dumerili) of carangidae.

The aquaculture device of the present invention can be further configured such that the at least one light emitting element is provided in water stored in the aquaculture region.

The light emitting element can be thus provided above the aquaculture region so as to emit light from above a fish preserve. Alternatively, the light emitting element can be thus provided in water so as to emit light in the water. It is preferable to provide the light emitting element in water because it is possible to optimize a distribution of fish by varying a depth at which the light emitting element is provided in the water.

The aquaculture device of the present invention can be further configured such that the supply current controlling section controls the driving current to be supplied to the at least one light emitting element from evening to tomorrow morning.

Young fish generally prefers a long light period. It is therefore preferable that the light emitting element emit artificial light from evening (sunset) to tomorrow morning.

The aquaculture device of the present invention can be further configured such that the supply current controlling section controls the driving current to be supplied to the at least one light emitting element for not less than 12 hours a day.

It is preferable that the at least one light emitting element emit light such that a light period becomes not less than 12 hours, in a season such as winter, when the light period becomes shorter. This allows an improvement in growth rate of young fish. The light emitted from the light emitting element can contain red components. It is, however, preferable that the light emitting element does not include red phosphors in terms of efficiency.

The present invention is not limited to the description of the embodiments above, and can therefore be variously modified by a skilled person in the art within the scope of the claims. Namely, an embodiment derived from a proper combination of technical means disclosed in different embodiments is encompassed in the technical scope of the present invention.

### INDUSTRIAL APPLICABILITY

An illumination device for use in aquaculture and an aquaculture device of the present invention are useful as an illumination device for use in aquaculture and an aquaculture device because they can reduce (i) power consumption and (ii) cost incurred by employing artificial light in addition to natural light.

### REFERENCE SIGNS LIST

1: fish preserve (aquaculture region)
2: water
3: fish
4: support pillar
5a: housing
5b: housing
6a, 6b and 6c: light emitting element
7: power supply
8: supply current controlling section
9: storage section
10: aquaculture device
11: first LED element group (first light emitting diode group)
12: second LED element group (second light emitting diode group)
13: anode electrode
14: gold
15: cathode electrode
16: line
17, 17a and 17b: pad electrode (anode)
18, 18a and 18b: pad electrode (cathode)
19: ceramic substrate
20: aquaculture device
21: phosphor
22: sealant resin
23: package
24: LED chip (light emitting diode)

1. An illumination device for use in aquaculture, comprising at least one light emitting element for emitting at least two types of light having respective emission peak wavelengths which are different, by not less than 5 nm, from each other in a range of 400 nm to 570 nm.

2. The illumination device for use in aquaculture as set forth in claim 1, wherein:
the at least one light emitting element includes a plurality of light emitting diodes having respective emission peak wavelengths which are different, by not less than 5 nm, from each other in a range of 480 nm to 520 nm.

3. The illumination device for use in aquaculture as set forth in claim 1, wherein:
the at least one light emitting element includes a plurality of light emitting diodes having respective emission peak wavelengths which are different, by not less than 5 nm, from each other in a range of 430 nm to 550 nm, and
at least one of the plurality of light emitting diodes emits light having an emission peak wavelength in a range of 500 nm to 550 nm.

4. The illumination device for use in aquaculture as set forth in claim 3, wherein:
at least one of the plurality of light emitting diodes belongs to a first light emitting diode group for emitting light having an emission peak wavelength in a range of 430 nm to 480 nm,
at least one of the others of the plurality of light emitting diodes belongs to a second light emitting diode group for emitting light having an emission peak wavelength in a range of 480 nm to 550 nm, and
the second light emitting diode group includes at least one light emitting diode for emitting light having the emission peak wavelength in the range of 500 nm to 550 nm.

5. The illumination device for use in aquaculture as set forth in claim 4, wherein:
the number of the at least one of the others of the plurality of light emitting diodes that belongs to the second light emitting diode group is greater than that of the at least one of the plurality of light emitting diodes that belongs to the first light emitting diode group.

6. The illumination device for use in aquaculture as set forth in claim 4, wherein:
the at least one of the others of the plurality of light emitting diodes that belongs to the second light emitting diode group needs a driving current greater than that of a light emitting diode, which belongs to the first light emitting diode group, for emitting light having an emission peak wavelength in a range of 430 nm to 470 nm.

7. The illumination device for use in aquaculture as set forth in claim 2, wherein:
the plurality of light emitting diodes are individually mounted.

8. The illumination device for use in aquaculture as set forth in claim 2, wherein:
the plurality of light emitting diodes are mounted in a single package.

9. The illumination device for use in aquaculture as set forth in claim 1, wherein:
the at least one light emitting element includes:
a light emitting diode for emitting light having an emission peak wavelength in a range of 400 nm to 460 nm; and
a phosphor for emitting, in response to the light emitted from the light emitting diode, fluorescence having an emission peak wavelength in a range of 480 nm to 570 nm, and
the light emitted from the light emitting diode and the fluorescence emitted from the phosphor are the two types of light.

10. The illumination device for use in aquaculture as set forth in claim 9, wherein:
the phosphor is any one of (i) BaSi₂O₂N₂:Eu, (ii) Lu₃Al₅O₁₂:Ce, (iii) Y₃(Al,Ga)₅O₁₂:Ce, (iv) Y₃Al₅O₁₂:Ce, (v) Sr₅F(PO₄)₃:Sb,Mn, (vi) Ca₃Sc₂Si₃O₁₂:Ce, and (vii) SrAl₂O₄:Eu²⁺,Dy³⁺.

11. The illumination device for use in aquaculture as set forth in claim 10, wherein:
the phosphor is one of Lu₃Al₅O₁₂:Ce and Ca₃Sc₂Si₃O₁₂:Ce.

12. The illumination device for use in aquaculture as set forth in claim 10, wherein:
the phosphor is SrAl₂O₄:Eu²⁺,Dy³⁺.

13. The illumination device for use in aquaculture as set forth in claim 9, wherein:
a ratio of (i) a photon flux density of the fluorescence emitted from the phosphor to (ii) a light flux density of the light emitted from the light emitting diode, is not less than two.

14. An illumination device for use in aquaculture as set forth in claim 1, further comprising:
a power supply for supplying a driving current to the at least one light emitting element; and
a supply current controlling section for controlling the driving current to be supplied to the at least one light emitting element.

15. The illumination device for use in aquaculture as set forth in claim 14, wherein:
the supply current controlling section controls the driving current, which is to be supplied to the at least one light emitting element, to be converted into a pulse current.

16. The illumination device for use in aquaculture as set forth in claim 15, wherein:
the pulse current has a frequency of not more than 10 Hz.

17. An aquaculture device, comprising:
an illumination device for use in aquaculture recited in claim 1;
an aquaculture region where fish is to be cultured;
a power supply for supplying a driving current to the at least one light emitting element; and
a supply current controlling section for controlling the driving current to be supplied from the power source to the at least one light emitting element.

18. The aquaculture device as set forth in claim 17, wherein:
the supply current controlling section controls the driving current, which is to be supplied to the at least one light emitting element, to be converted into a pulse current.

19. The aquaculture device as set forth in claim 18, wherein:
the pulse current has a frequency of not more than 10 Hz.

20. The aquaculture device as set forth in claim 17, wherein:
the fish is young fish.

21. The aquaculture device as set forth in claim 20, wherein:
the young fish is 70 days old or younger.

22. The aquaculture device as set forth in claim 17, wherein:
the fish is thunnus.

23. The aquaculture device as set forth in claim 17, wherein:
the fish is any one of carangidae, sparidae, gadinae, salmonidae, percichthyidae, latridae, and siganidae.

24. The aquaculture device as set forth in claim 17, wherein:
the at least one light emitting element is provided in water stored in the aquaculture region.

25. The aquaculture device as set forth in claim 17, wherein:
the supply current controlling section controls the driving current to be supplied to the at least one light emitting element from evening to tomorrow morning.

26. The aquaculture device as set forth in claim 17, wherein:
the supply current controlling section controls the driving current to be supplied to the at least one light emitting element for not less than 12 hours a day.
